(19) United States
(12) Patent Application Publication
(10) Pub. No.: US 2005/0194502 A1
(43) Pub. Date: Sep. 8, 2005

(54) Handlebar storage unit

(76) Inventor: Sandra Montgomery, Amherst, NY (US)

Correspondence Address: HODGSON RUSS LLP, ONE M & T PLAZA, SUITE 2000, BUFFALO, NY, 14203-2391, US

(21) Appl. No.: 11/021,880

(22) Filed: Dec. 23, 2004

Related U.S. Application Data
(60) Provisional application No. 60/550,251, filed on Mar. 4, 2004.

(51) Int. Cl. F16M 11/00

(52) U.S. Cl. 248/174

(57) ABSTRACT

A storage unit for use on a handlebar of a piece of exercise equipment, such as a spinning bike or cycling bike. The storage unit comprises a first handle receiving portion defining an opening or recess, a second handle receiving portion defining an opening or recess, and a support portion joined to the first handle receiving portion and the second handle receiving portion. First and second elastic edges extend along the edges of the storage unit. The recesses are used for receiving the handles of a handlebar therein. The storage unit comprises a four-way stretch material so that it can be manually stretched from a relaxed position and slid or positioned on the handlebars of the exercise bike. As personal articles are then placed in the support portion the support portion sags, and the first and second elastic edges prevent the storage unit from twisting, so that the personal articles do not fall out of the support portion while the person exercises. A pocket can be joined to the storage portion and articles can be stored therein.

### BENEFIT CLAIM OF AN EARLIER FILED APPLICATION

This application claims the benefit of U.S. Provisional Patent Application No. 60/550,251, filed Mar. 4, 2004 to Montgomery.

### BACKGROUND

Cycling on stationary bikes and spinning on spinning bikes is a very popular activity, because it provides a simple effective way for individuals to become physically fit and to maintain their current level of physical fitness. Indeed, spinning is so popular that many people regularly attend spinning classes. Furthermore, cycling on an indoor stationary bike or spinning on an indoor spinning bike is popular because it allows a person to exercise regardless of weather conditions and the time of day, and the person does not have to worry about road traffic.

Cycling on a stationary bike or spinning on a spinning bike, however, in a gym or workout facility has a number of drawbacks. For example, a person at a gym who wants to exercise on these bikes has no convenient place to store his or her keys, wallet, purse, pager, tissues, towel, cell phone, glasses, CD/tape player, radio, and other personal articles. As a result, these small personal articles and are frequently placed on the floor next to the stationary or spinning bike and may become lost, or they may be mistakenly taken by another person at the gym. Even worse, they may be stolen, because the person cycling or spinning cannot monitor his or her personal articles on the floor. Also, there is always the possibility that larger personal items left on the floor may be stepped on and broken.

One of the items people who cycle or spin often bring to the gym is a water bottle, and some people bring several water bottles. Although many exercise bikes have a water bottle holder, not all water bottles fit in the holder and there is no room to accommodate a second or third bottle of water. If the exercise bike has no water bottle holder or has an unsuitable water bottle holder, then the person must place the water bottle, along with other personal articles, on the floor where it is difficult to access.

Hence, there is a need to provide people who use stationary bikes, spinning bikes, and other exercise equipment with a way to monitor and have access to their personal articles while they cycle, spin, or exercise.

### SUMMARY

The storage unit according to the invention solves the above-described problems encountered by people who use stationary bikes, spinning bikes, and other exercise equipment. The storage unit can be readily positioned on the handle portions of a spinning bike handlebar, thus allowing the person spinning or cycling to have access to his or her personal articles and water bottles at all times. Thus, the storage unit advantageously decreases the likelihood of the personal articles becoming lost, misplaced, confused with the personal article of another, stepped on, or stolen.

The storage unit has a first handle receiving portion, a second handle receiving portion, and a support portion. The support portion is joined to the first handle receiving portion and is joined to the second handle receiving portion, such that the support portion extends between the first handle receiving portion and the second handle receiving portion. The first handle receiving portion defines an opening or recess and the second handle receiving portion defines an opening or recess. The openings are for receiving the handle portions of the bike or other exercise equipment.

The storage unit has a first elastic edge that extends along the length of the support portion and around the first and second handle receiving portions. The storage unit also has a second elastic edge that extends along the length of the support portion and around the first and second handle receiving portions. The first elastic edge comprises a first strip of elastic, and the second elastic edge comprises a second strip of elastic. The first and second elastic edges stabilize the edges of the storage unit, allow for the formation of the support portion, and prevent the support portion from twisting when loaded with personal articles.

The storage unit is formed from a sheet of material, preferably rectangular in shape, having a pair of side edges and a pair of end edges. The sheet of material is flexible. The first strip of elastic is sewn to the sheet of material adjacent one of the side edges, and the second strip of elastic sewn to the sheet of material adjacent the other side edge, to thus form the first and second elastic edges.

Then, the two end edges are each folded until they contact the sheet of material and are then sewn or joined to the sheet of material. This forms the first and second handle receiving portions, respectively. The first handle receiving portion defines an opening or recess surrounded by the first and second elastic edges, and the second handlebar receiving portion defines an opening or recess also surrounded by the first and second elastic edges. The sheet of material can comprise a flexible four-way stretch material, nylon, spandex, terrycloth, stretch terrycloth, cloth, rubber, and combinations thereof.

The support portion can have a pocket joined to it, and/or a grommet joined to it. Additionally, the ends of an elastic band can be joined to the support portion the elastic band can be used to hold cell phones, pagers, and the like.

In another embodiment, a continuous loop storage unit is provided. The continuous loop storage unit comprises a sheet of material that can be a flexible four-way stretch material as described in connection with the first embodiment. The sheet of material has a first edge and a second edge, and a third edge and a fourth edge. A first elastic edge extends along the third edge, and a second elastic edge extends along the fourth edge. The first edge and the second edge are joined together, thus forming the continuous loop storage unit. It is noted that in this embodiment, the sheet of material can have non-parallel sides.

There is also provided a method of making a storage unit for holding or supporting personal articles. The method comprises providing a sheet of material having a pair of side edges and a pair of end edges. The method further includes providing first and second strips of elastic and positioning one of the strips on the sheet of material adjacent the one of the side edges and sewing the two together, and placing the other strip on the sheet of material adjacent the other side edge and sewing the two together. This is followed by folding each of the end edges until they contact the sheet of material and sewing or joining the end edges to the sheet of material. The storage unit is thus formed.

### BRIEF DESCRIPTION OF THE FIGURES

At the outset, it noted that like reference numbers are intended to identify the same structure, portions, or surfaces consistently throughout the figures.

FIG. 1 is a front perspective view of the storage unit.

FIG. 2 is a top perspective view of the storage unit.

FIG. 3 is a bottom plan view of the storage unit.

FIG. 4 is top plan view of the storage unit.

FIG. 5 is a front elevational view of the storage unit.

FIG. 6 is a rear elevational view-of the storage unit.

FIG. 7 is a left side elevational view of the storage unit.

FIG. 8 is a right side elevational view of the storage unit.

FIG. 9 is a top plan view of the storage unit positioned on the handlebars of a stationary bike.

FIG. 10 is a perspective view of the storage unit installed on a stationary bike and supporting personal articles.

FIG. 11 is a top plan view of the sheet from which the storage unit is formed.

FIG. 12 is a front perspective view of a second embodiment of the storage unit.

FIG. 13 is a top plan view of the second embodiment of the storage unit.

FIG. 14 is a left side elevational view of the second embodiment of the storage unit installed on the handle of a piece of exercise equipment.

FIG. 15 is a top plan view of the second embodiment of the storage unit installed on the handlebar of a piece of exercise equipment.

FIG. 16 is a plan view of the flexible sheet of material used to form the storage unit of the second embodiment.

FIG. 17 is a top plan view of another embodiment of the handlebar storage unit.

FIG. 18 is a top plan view of a piece of material that is used for forming a pocket.

FIG. 19 is a top plan view of the edges of the sheet of material turned under before stitching the sheet of material to form a pocket.

FIG. 20 is a top plan view of the piece of material joined to the support portion to form a pocket.

### DETAILED DESCRIPTION

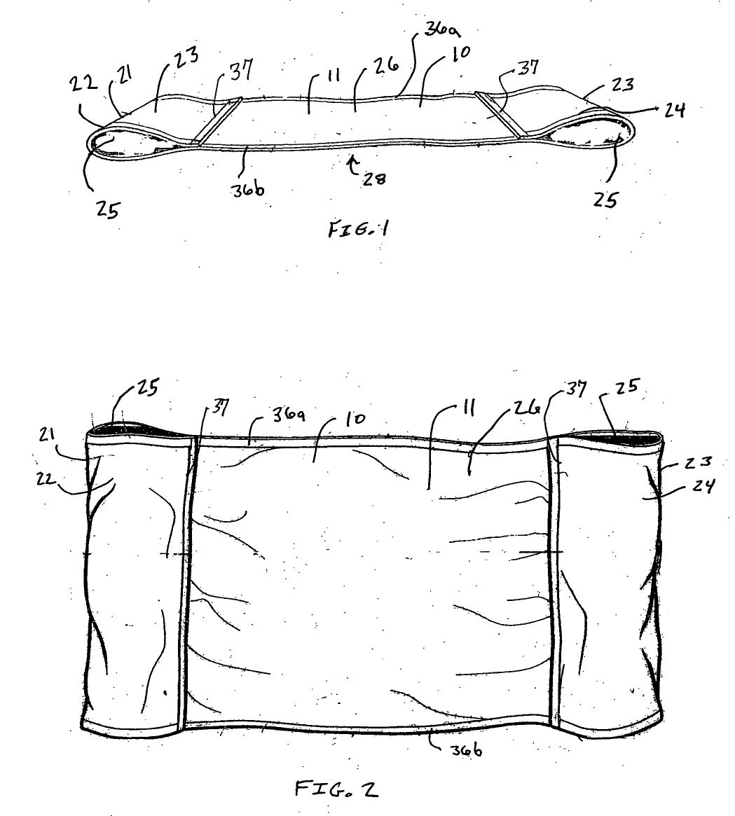

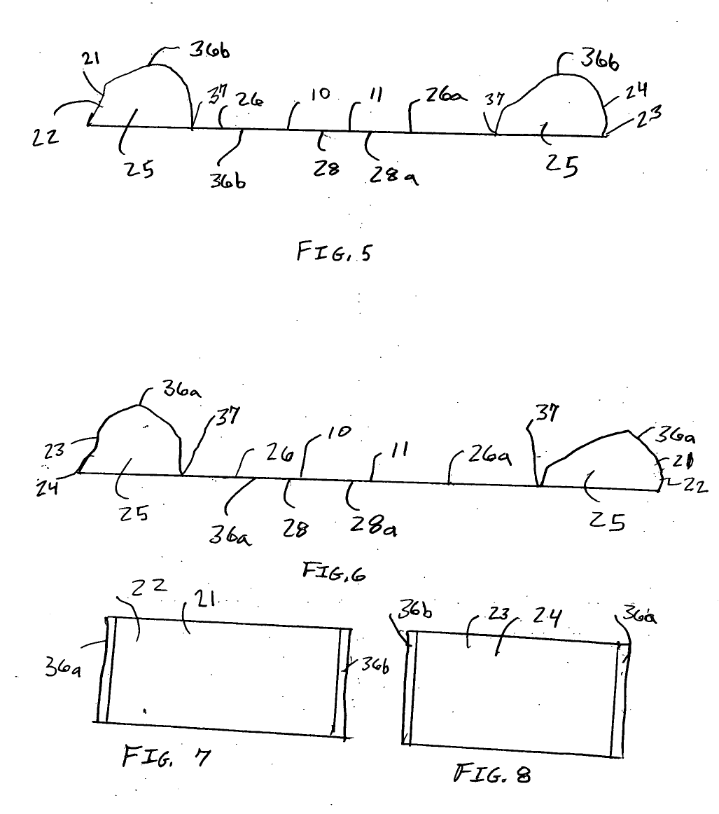

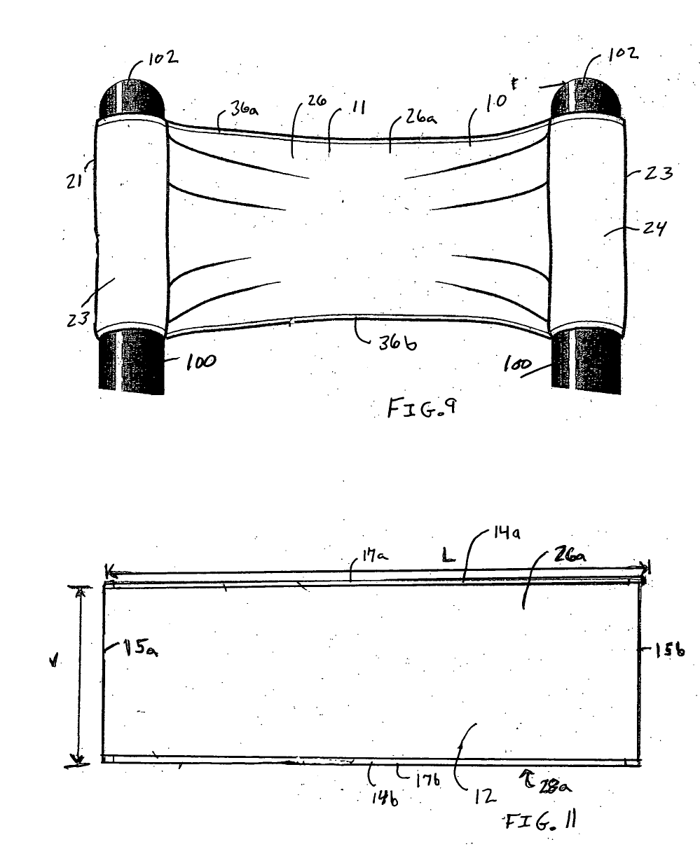

The storage unit 10 according to the invention is shown in FIGS. 1-10. FIGS. 9 and 10 show the storage unit 10 supported between a pair of handles 102. The handles 102 extend from a handlebar 100 of an exercise bike, for example a spinning bike or stationary exercise bike, generally designated 98, or other piece of exercise equipment. A cyclist or spinner (not shown) places his or her personal articles 104 on in the support portion 11 of the handlebar storage unit 10 while he or she is spins or cycles. The articles 104 can comprise a wallet, a purse, a pager, tissues, a cell phone, a water bottle, glasses, a CD/tape player, keys, a radio, a towel, and other articles 104 one typically carries on his or her person.

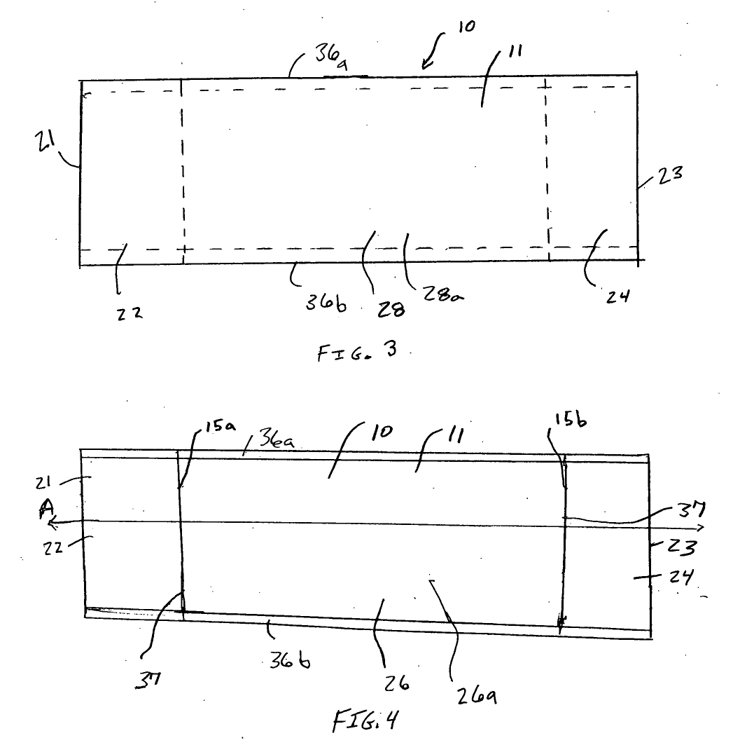

As shown in FIGS. 1-2, and 5-6, formed at a first end 21 of the storage unit 10 is a first handle receiving portion 22, and formed at a second end 23 of the storage unit 10 is a second handle receiving portion 24. The first and second handle receiving portions 22, 24, respectively define handle openings or recesses, commonly designated 25. The storage unit 10 further comprises a support portion 11 having a first side 26 and a second side 28, as shown also in FIGS. 5 and 6. The support portion 11 extends between the first and second handle receiving portions 22, 24, respectively. The first and second handle receiving portions 22, 24, respectively are also shown in FIGS. 3-6.

The storage unit 10 has a longitudinal axis, designated in A in FIG. 4, and also has two spaced apart first and second elastic edges 36a, 36b, respectively, that extend in the direction of the longitudinal axis. In one of the preferred embodiments, the first and second elastic edges 36a, 36b are substantially parallel. The first and second elastic edges 36a, 36b are straight where they extend along the support portion 11, and are curved where they extend around the periphery of the handle openings 25, as shown in FIGS. 1-2, and 5-6.

The support unit 10 can be stretched in the direction of its longitudinal axis A such that the openings 25 defined in the first and second handle receiving portions, 22, 24, respectively, align with the handles 102 of the spinning bike 98. The first and second handle receiving portions 22, 24, respectively, are then slid over or positioned around the handles 102 of the handlebar 100, as shown in FIGS. 9 and 10. Personal articles 104 can then be placed on the storage portion 11. The first and second elastic edges 36a, 36b, respectively, prevent the storage unit 10 from twisting or flipping over, and also support personal articles 104 placed on the storage portion 11 of the storage unit 10.

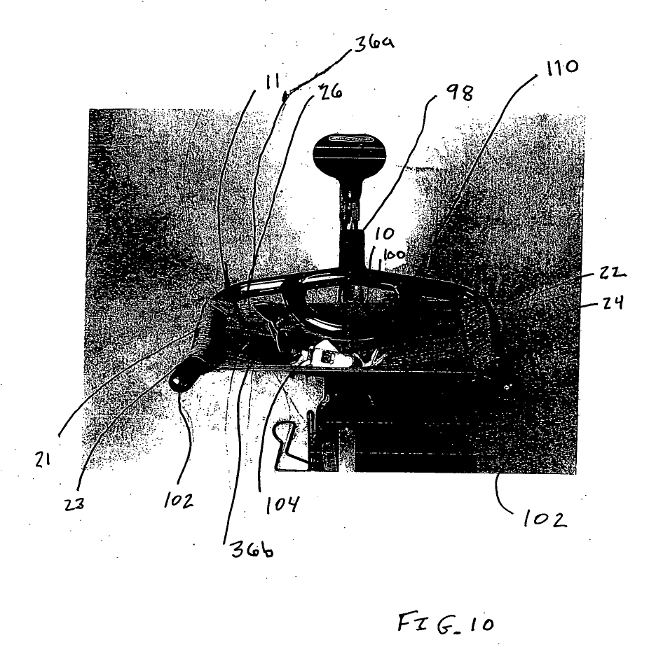

As shown in FIG. 11, the storage unit 10 is formed from a sheet of material 12. In one of the preferred embodiments the sheet of material 12 comprises a rectangular-shaped flexible four-way stretch material. The storage unit 10 is also formed from first and second strips of elastic 14a, 14b, respectively. FIG. 11 is a plan view of the sheet of material 12 and the first and second strips of elastic 14a, 14b, respectively, before they are sewn together to form the storage unit 10. The sheet of material 12 has a first surface 26a and an oppositely facing second surface 28a. The flexible sheet of material 12 also has a first edge 15a and a second edge 15b, that span the width, designated W in FIG. 11, of the flexible sheet of material 12. Edges 15a and 15b may also be designated end edges. The flexible sheet of material 12 also has a third edge 17a and a fourth edge 17b that span the length, designated L in FIG. 11, of the flexible sheet of material 12. Edges 17a and 17b may also be designated side edges. In one of the preferred embodiments, the first edge 15a and second edge 15a are substantially parallel, and the third edge 17a and fourth edge 17b are substantially parallel.

Also, in one of the preferred embodiments, the sheet of material 12 comprises a sheet of four-way stretch nylon. Nylon, which is well known to those skilled in the art, is flexible and can be stretched and is resilient. The four-way stretch nylon can be stretched such that its length and width increases when it is subjected to tension forces. Then, when the tension forces are removed, the four-way stretch nylon relaxes and returns to its pre-stretched or pre-deformed state. The four-way stretch nylon can be a sheet of nylon that, in its relaxed state, is about twenty-three inches in length and about eleven inches in width. The sheet of material 12 may also comprise a resilient synthetic polymer. Resilient synthetic polymers are also well known to those having ordinary skill in the art. In another preferred embodiment the sheet of material 12 may comprise a sheet of LYCRA® that, in its relaxed state, is about twenty-three inches in length by about eleven inches in width. LYCRA® is a registered trademark owned by E.I. du Pont de Nemours and Company, 1007 Market Street, Wilmington, Del. 19898. LYCRA® is commercially available and well known to those having ordinary skill in the art. The sheet of material 12 may also comprise spandex, and spandex is well known to those having ordinary skill in the art. In other embodiments the sheet of material 12 may be made of other types of flexible four-way stretch materials well known to those having ordinary skill in the art. For example, the sheet of material 12 may comprise fabric, cloth, woven fabric, non-woven fabric, rubber, synthetic rubber, and combinations thereof.

To form the storage unit 10, the first strip of elastic 14a, and second strip of elastic 14b are provided, as shown in FIG. 11. The strips of elastic 14a, 14b, respectively, can be a flexible stretchable fabric made of natural or synthetic fibers, and strips of elastic are commercially available and well known to those having ordinary skill in the art.

The first strip of elastic 14a is positioned on the first side 26a of the sheet of material 12 such that is parallel with and aligned with the third edge 17a, as shown in FIG. 11. The second strip of elastic 14b is positioned on the first side 26a such that it is parallel with and aligned with to the fourth edge 17b, as shown in FIG. 11. Then the portions of the sheet of material along the side edges 17a, 17b are folded over the first and second elastic strips 14a, 14b, such that after folding, the first and second strips of elastic 14a, 14b, respectively, are each completely covered or encased by the sheet of material 12. It is noted that in one of the preferred embodiments the first and second strips of elastic 14a, 14b, respectively, are each about a quarter of an inch wide and about twenty-three inches long.

Then, the folded over portions of the sheet of material 12 along the third and fourth edges 17a, 17b, respectively, are sewn or joined to the first side 26a of the flexible sheet of material 12. As this sewing takes place, the first strip of elastic 14a is sewn to the flexible sheet of material 12. A straight stitch sewing machine can be used to carry out the sewing of the first strip of elastic 14a to the flexible sheet of material 12. As this sewing is carried out, the first strip of elastic 14a is stretched or taught from its relaxed state while it is being sewn to the sheet of material 12. It is noted that the technique of sewing taught elastic to material is well known to those having ordinary skill in the art. The second strip of elastic 14b is sewn in the same manner to the sheet of material 12. It is noted that a serger or overlock sewing machine may be used to carry out the sewing, and that these machines are well known to those having ordinary skill in the art.

After sewing, the first and second strips of elastic 14a, 14b, respectively, are surrounded or encased in the sheet of material 12, and the first and second elastic edges 36a, 36b, respectively, are thus formed. Additionally, the first and second strips of elastic 14a, 14b, respectively, return-to their relaxed state, which causes the first and second elastic edges 36a, 36b, respectively, to have a rippled appearance. This is because the sewn sheet of material 12 is pulled into ripples by the relaxed first and second strips of elastic 14a, 14b, respectively. It is noted that the first and second strips of elastic 14a, 14b, respectively, can be sewn to the flexible sheet of material 12 one at a time as described above, or both at the same time.

Additionally, in other embodiments, the first and second strips of elastic 14a, 14b, respectively, may be sewn to the sheet of flexible material 12 without being taught, that is, the first and second strips of elastic 14a, 14b, respectively, are in a relaxed state or condition when sewn.

After the first and second strips of elastic 14a, 14b, respectively are joined to the sheet of material 12, the first and second handlebar receiving portions 22, 24, respectively, are formed. This is accomplished by folding each of the first and second edges 15a, 15b, respectively, in on themselves such that they contact the first surface 26a of the flexible sheet of material 12, as shown in FIGS. 1, 5 and 6. The first and second edges 15a, 15b, respectively, are sewn to the first surface 26a along stitch lines, commonly designated 37. The first and second edges 15a, 15b, respectively, can be sewn one at a time or both at the same time.

After the sewing is completed, the first and second handlebar receiving portions 22, 24, respectively, are formed. The first handlebar receiving portion 22 is thus defined by the first and second elastic edges, 36a, 36b, respectively, and the included portion of the sheet of fabric 12, as shown in FIG. 1-2, and 4-8. The second handlebar receiving portion 24 is thus defined by the first and second elastic edges, 36a, 36b, respectively, and the included portion of the flexible sheet of fabric 12, as shown in FIG. 1-2, and 4-8. The first and second handlebar receiving portions 22, 24, respectively, thus define openings or recesses 25. The handles 102 of the bike 98 can be positioned in these openings 25. The storage unit 10 is now ready for use by a spinner or cyclist.

The above-described storage unit 10 advantageously is very easy for a person to install on the handlebar 100 of the spinning bike 98. Once the storage unit is installed it becomes part of a storage system 110 for personal articles 104. The storage system 110 comprises the spinning bike 98 or exercise machine and the storage unit 10. An installed storage unit 10 is shown in FIGS. 9 and 10. To install the storage unit 10 the handle opening or recess 25 defined in the first handlebar receiving portion 22 is aligned with the end of one of the handles 102 of the handlebar 100, and portion 22 is slid over and onto the handle 102. Next, the storage unit 10 is manually stretched in its longitudinal direction, designated A, and the second handlebar receiving portion 24 is slid over the other handle 102 of the handlebar 100, in a manner similar to that of portion 22. It not difficult for the cyclist/spinner to manually expand/stretch the support unit 10 and position the first and second handlebar receiving portions 22, 24, respectively, about the handlebars 100. This is because the storage unit 10 advantageously comprises a sheet of flexible material 12 with elastic strips 14, that is not difficult to manually stretch. Additionally, the four-way stretch material and elastics allow the storage unit 10 to be installed on exercise bikes having handlebars 100 having differently spaced handles 102, because the storage unit 10 can be stretched to accommodate these various sized handlebars 100.

It is noted that the storage unit 10 advantageously can be installed with the first side 26 facing the cyclist or spinner, or may be installed with the second side 28 facing the cyclist or spinner. This is possible because the storage unit 10 functions properly regardless of the orientation in which it is installed.

Additionally, the first and second elastic edges 36a, 36b, respectively, advantageously provide for stabilization of the storage unit 10 after it has been installed on the handlebar 100. For example, after installation of the storage unit 10 on the handlebar 100, the spinner/cyclist (not shown) places his or her personal article 104 on the support portion 11 formed in the first side 26 of the storage unit. The cyclist or spinner can place personal articles 104, including towels, glasses, keys, a cell phone, a pager, a water bottle, a CD/tape player, and the like in the storage portion 11 of the support unit 10. As shown in FIG. 10, the support portion 11 thus sags in a direction toward the floor of the gym due to gravity forces acting on the articles 104. As more articles 104 are added to the support unit 10, the more the support portion 11 sags. However, at no time while a user spins on the spinning bike 98 can the articles 104 bounce out of the storage unit 10. The first and second elastic edges 36a, 36b, respectively, advantageously prevent the storage unit 10 from twisting or flipping under the load of the articles 104.

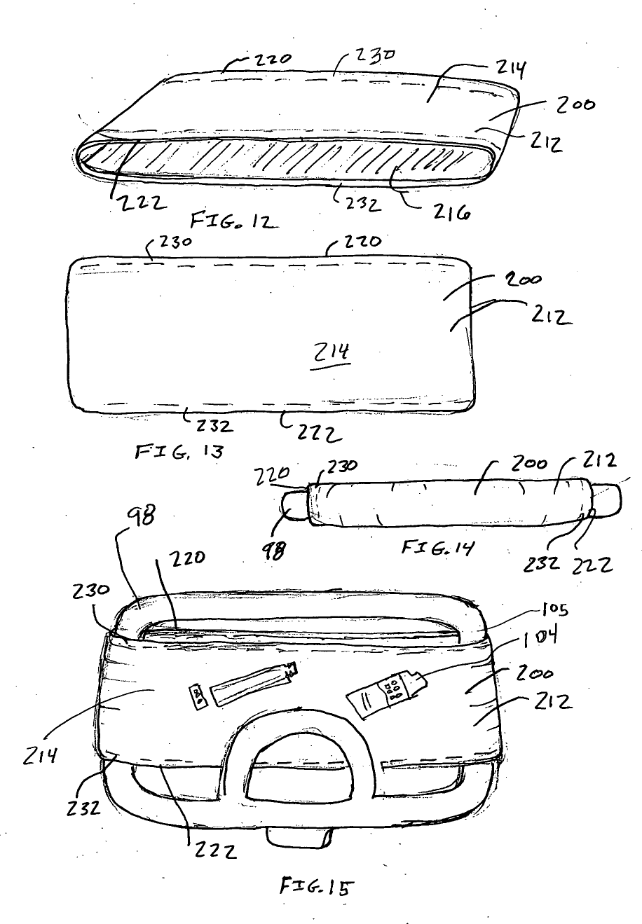

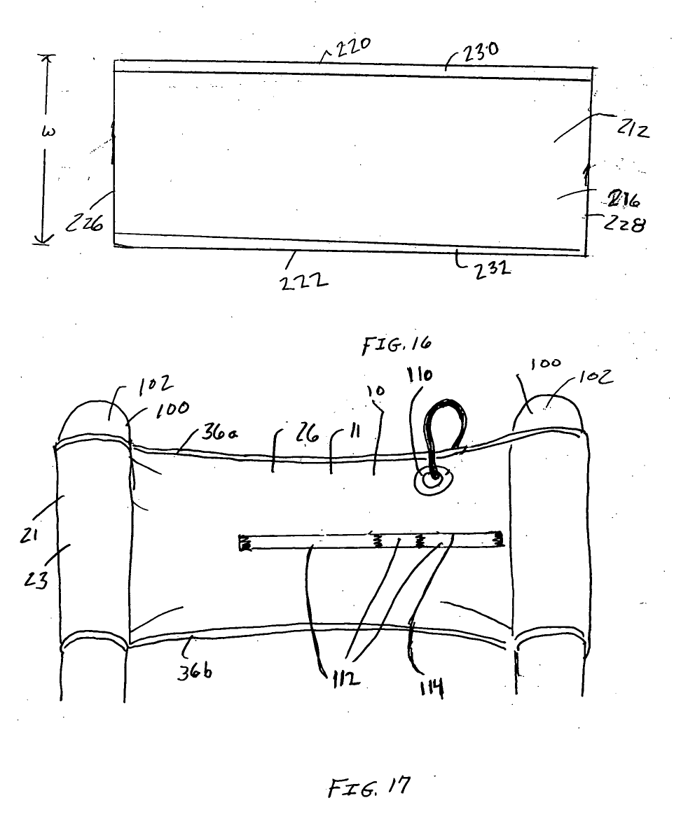

In another embodiment, a continuous loop storage unit 200 is provided, as shown in FIGS. 12-16. In FIG. 12, the continuous loop 200 storage unit has a cylindrical or tubular shape and has a support portion 202, as shown in FIGS. 12 and 15. This continuous loop storage unit 200 can be used on handlebars that have a rectangular shape as shown in FIG. 15, as well as on the above-described handlebars 100 that have handle portions 102. In this embodiment, the continuous loop storage unit 200 is formed from a sheet of material 212 having a first surface 214 and an oppositely facing second surface 216, as shown in 16. The sheet of material 212 comprises a four-way stretch material that is the same as the sheets of material described in connection with the first embodiment. The sheet of material 212 also has a first edge 220 and a second edge 222 with the width of the sheet of material 212 separating the first and second edges 220, 222, respectively. The flexible sheet of material also comprises first and second seam edges, 226, 228. The continuous loop storage unit 200 comprises first and second elastic edges 230, 232, respectively, shown in FIGS. 12-15. The first and second elastic edges 230, 232, respectively are formed from first and second strips of elastic 229, 231, respectively, as shown in 16. The first and second elastic edges 230, 232, respectively are formed in the same manner as elastic edges described above in connection with the description of the first embodiment.

The continuous loop storage unit 200 is formed when the first and second seam edges 226, 228, respectively, are joined or sewn together. A continuous loop storage portion 211 is formed between the first and second elastic edges 230, 232, respectively. The first continuous loop storage portion 211 can then be loaded with articles 104 when the continuous loop storage unit 200 is fitted or positioned about a rectangular handlebar 105, as shown in FIG. 15. The flexible sheet of material in this embodiment can have a width of about twelve inches and can have a length of about thirty-six inches. It is noted that the sheet of material 212 in this embodiment may be trapezoidal shaped or rectangular shaped.

To install, the continuous loop storage unit 200 is stretched over the rectangular handlebar 105 shown in FIG. 15, or around the above-described handle portions 102. Articles 104 are then placed on the first surface 214 and in the storage portion 211. It is noted that the continuous loop storage unit 200 can be turned inside out, such that the second surface 216 faces outward and articles 104 can be placed thereon.

A grommet 110 can be attached to the storage unit 10 or the continuous loop storage unit 200, the grommet 110 shown in FIG. 17. A sweat towel or locker keys and other items can be joined to the grommet 110. In addition, a band or bands of elastic 114 can be sewn or otherwise joined to the storage portion 11 or continuous loop storage portion 211. A cell phone or pager can be positioned between the band of elastic 114 and the storage portion 11 or continuous loop storage portion 211.

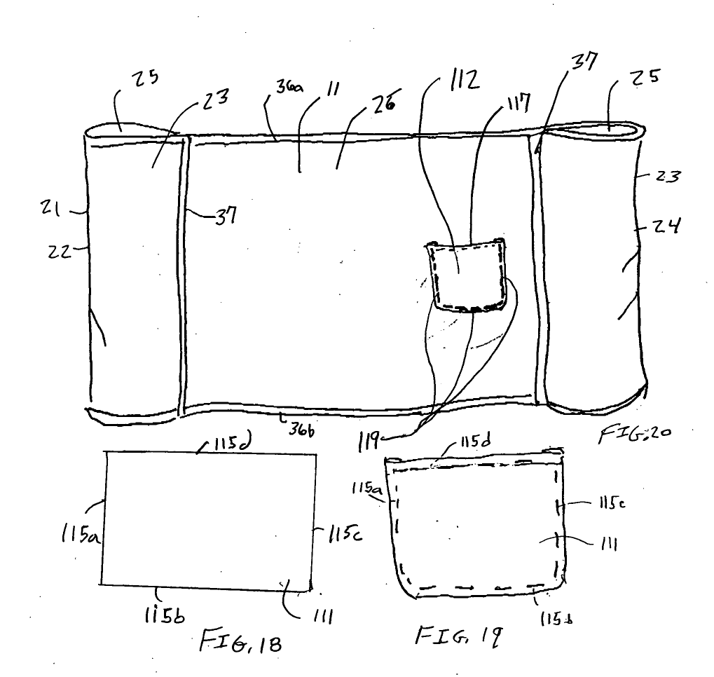

FIG. 18 is a top plan view of a piece of material 111 used for forming a pocket 112 in the storage unit 10 or in the continuous loop storage unit 200. In particular, a rectangular piece of fabric or LYCRA® is provided having a first edge 115a, a second edge 115b, a third edge 115c, and a fourth edge 115d . As shown in FIG. 19, the first, second, third, and fourth edges 115a, 115b, 115c, 115d respectively, are turned under on themselves. Then, as shown in FIG. 20, the sheet of material 111 is joined or stitched to the storage portion 11 along three stitch lines 119. After stitching, the pocket 112 is formed and has a pocket opening 117. Personal articles 104, pagers, cell phones, and the like can be stored in the pocket 112.

Also, in other embodiments of the storage unit 10 and continuous loop storage unit 200, can each have a towel or terry cloth cover joined to it to prevent sweat from dripping on the articles 104 and on the bike. In other embodiments, the sheet of material used in the first and second embodiments, 12 and 212, may also comprise stretch terrycloth, which can double as a sweat towel. The sweat towel protects the bicycle from sweat dripping onto any metal parts of the bicycle. Terrycloth and stretch terrycloth are well known to those having ordinary skill in the art.

Also, in other embodiments, the flexible sheet of material 12 may be made of rubber or plastic. It is noted that if the material comprises plastic, the storage unit will have a length greater than the width between the handles 102 of the handlebar 100. This allows for slack when the storage unit is installed on the handlebar 100, which allows the support portion to sag in a direction toward the gym floor when it is loaded with personal articles 104.

Some of the advantages of the storage unit 10 and continuous loop storage unit 200 are that they are inexpensive to manufacture, can be mass produced, and are easy to install and use. Furthermore, the storage unit 10 solves the problems associated storing personal items while cycling/spinning on a stationary exercise bike or spinning bike at a gym or workout facility. Additionally, the cyclist always has his or her personal articles in view, and in a convenient location so that they can be readily accessed. Also, after use the storage unit 10 and continuous loop storage unit 200 can be folded into a compact size. Furthermore, the storage unit 10 and continuous loop storage unit 200 are easy to clean, and have a long working life.

The storage units 10 and 200 may be used on virtually all spinning bicycles and stationary exercise bikes, magnetic resistance exercise bikes, and other resistance type exercise bikes that have handlebars 100 about which the first and second handlebar receiving portions 22, 24, respectively can be positioned, or the continuous loop storage unit 200 can positioned around. Additionally, it is noted that the storage unit 10 or continuous loop storage unit 200 can be installed on any piece of exercise equipment having handles between which the storage unit 10 can be stretched, or the continuous loop storage unit 200 can be positioned around. Thus, the present storage units 10, 200, respectively can be installed on a weight lifting machine or tread mill or other piece of exercise equipment so long as there are handles on the piece of exercise equipment.

It will be appreciated by those skilled in the art that while the storage unit has been described above in connection with particular embodiments and examples, the storage unit is not necessarily so limited and other embodiments, examples, uses, and modifications and departures from the embodiments, examples, and uses may be made without departing from the scope of the invention in the storage unit. All of these alternative embodiments are intended to be within the scope and spirit of this invention.

1. A storage unit comprising:
a) a first handle receiving portion,
b) a second handle receiving portion, and
c) a support portion joined to the first handle receiving portion and the second handle receiving portion such that the support portion extends between the first handle receiving portion and the second handle receiving portion for receiving therein at least one article to be stored.

2. The storage unit according to claim 1 wherein the first handle receiving portion defines a recess for receiving a handle.

3. The storage unit according to claim 1 wherein the second handle receiving portion defines a recess for receiving a handle.

4. The storage unit according to claim 1 further comprising a first elastic edge joined to the support portion and a second elastic edge joined to the support portion for preventing the support portion from twisting.

5. The storage unit according to claim 4 wherein the support portion comprises a sheet of material and wherein the first elastic edge comprises a first strip of elastic sewn to the sheet material and the second elastic edge comprises a second strip of elastic sewn to the sheet of material.

6. The storage unit according to claim 4 wherein first handle receiving portion defines an recess and the second handle receiving portion defines a recess and wherein the first elastic edge and the second elastic edge surround a corresponding periphery of each of the recesses and further wherein the first elastic edge and the second elastic edge each comprise a strip of elastic.

7. The storage unit according to claim 1 wherein the first handlebar receiving portion defines a recess and the second handlebar receiving portion defines a recess and wherein a first elastic edge and a second elastic edge surround a corresponding periphery of each of the recesses.

8. The storage unit according to claim 1 wherein the first handle receiving portion, the second handle receiving portion, and the support portion each comprise four-way stretch material.

9. The storage unit according to claim 8 wherein the four-way stretch material comprises nylon.

10. The storage unit according to claim 8 wherein the four-way stretch material comprises spandex.

11. The storage unit according to claim 1 wherein the first handle receiving portion, the second handle receiving portion, and the support portion comprise terrycloth.

12. The storage unit according to claim 1 wherein the first handle receiving portion, the second handle receiving portion, and the support portion comprise plastic.

13. The storage unit according to claim 1 further comprising a grommet joined to the storage portion and an elastic band joined having ends wherein each end is joined to the storage portion.

14. The storage unit according to claim 1 further comprising a pocket formed in the storage portion.

15. A storage unit comprising:
a) a sheet of material having a first elastic edge and a second elastic edge,
b) the sheet of material having a first seam edge and a second seam edge such that the first elastic edge and second elastic edge are spaced from one another by the first seam edge and second seam edge, and
c) wherein the first seam edge and the second seam edge are joined with one another to form a support portion extending between the first elastic edge and the second elastic edge for receiving at least one article to be supported.

16. The storage unit according to claim 15 wherein the first seam edge and the second seam edge join together to form a continuous loop storage unit.

17. The storage unit according to claim 15 further comprising a grommet joined to the support portion and the support portion having a pocket.

18. The storage unit according to claim 17 wherein the first elastic edge comprises a first strip of elastic sewn to the sheet of material and the second elastic edge comprises a second strip of elastic sewn to the sheet of material.

19. The storage unit according to claim 18 wherein the sheet of material comprises a four-way stretch material.

20. The storage unit according to claim 18 wherein the four-way stretch material comprises nylon.

21. The storage unit according to claim 15 wherein the sheet of material comprises a four-way stretch material.

22. The storage unit according to claim 21 wherein the four-way stretch material comprises terrycloth.

23. The storage unit according to claim 21 wherein the four-way stretch material comprises nylon.

24. A personal article support system for use while exercising, the support system comprising:
a) a piece of exercise equipment having a pair of handles,
b) a storage unit having a first handle receiving portion, a second handle receiving portion, and a support portion joined to the first handle receiving portion and the second handle receiving portion such that the support portion extends between the first handle receiving portion and the second handle receiving portion, and
c) wherein the first handle receiving portion is positioned around one of the handles and the second handle receiving portion is positioned around the other handle, such that the storage unit extends between and is supported by the handles.

25. The support system according to claim 24 wherein the first handle receiving portion defines a recess for receiving one of the handles and the second handle receiving portion defines a recess for receiving the other handle.

26. The support system according to claim 24 further comprising a first elastic edge joined to the support portion and a second elastic edge joined to the support portion.

27. The support system according to claim 26 wherein the first elastic edge comprises a first strip of elastic and the second elastic edge comprises a second strip of elastic.

28. The support system according to claim 27 wherein the first handle receiving portion defines a recess and the first elastic edge and second elastic edge surround the recess and wherein the second handle receiving portion defines a recess and the first elastic edge and second elastic edge surround the recess.

29. The support system according to claim 24 wherein the first handle receiving portion, the second handle receiving portion, and the support portion comprise four-way stretch material.

30. The support system according to claim 29 wherein the four-way stretch material comprises nylon.

31. The support system according to claim 29 wherein the four-way stretch material comprises spandex.

32. The support system according to claim 24 wherein the storage unit comprises cloth.

33. A method of making a support unit for supporting personal articles while exercising, the method comprising:
providing a sheet of material,
providing the sheet of material with first and second edges,
providing the sheet of material with third and fourth edges,
providing first and second strips of elastic and positioning the first strip of elastic on the sheet of flexible material adjacent to the third edge and positioning the second strip of elastic on the sheet of flexible material adjacent the fourth edge,
folding the third edge and encasing the first strip of elastic in the sheet of material and joining the first strip of elastic to the sheet of material and folding the fourth edge and encasing the second strip of elastic in the sheet of material and joining the second strip of elastic to the sheet of material, and
folding the first edge until it contacts the sheet of material and joining the first edge to the sheet of material and folding the second edge until it contacts the sheet of material and joining the second edge to the sheet of material.

34. The method of making a storage unit method according to claim 33 further comprising using a sewing machine to join the first edge and the second edge to the sheet of material and using the sewing machine to join the third edge and the fourth edge to the sheet of material.

35. The method of making a storage unit according to claim 33 wherein the sheet of material comprises four-way stretch material.
